(19) United States
(12) Patent Application Publication
(10) Pub. No.: US 2014/0027660 A1
(43) Pub. Date: Jan. 30, 2014

(54) LOW LEAKAGE FLUE DAMPER

(71) Applicant: FIELD CONTROLS, LLC, Kinston, NC (US)

(72) Inventor: Steven E. Guzorek, Kinston, NC (US)

(73) Assignee: FIELD CONTROLS, LLC, Kinston, NC (US)

(21) Appl. No.: 13/947,773

(22) Filed: Jul. 22, 2013

Related U.S. Application Data
(60) Provisional application No. 61/675,209, filed on Jul. 24, 2012.

(51) Int. Cl. F23L 11/00; F16K 1/226

(52) U.S. Cl. CPC F23L 11/00; F16K 1/226
USPC 251/306

(57) ABSTRACT

A flue damper comprises a damper gate having first and second sides, and first and second seal stops. In one embodiment, a first seal is mounted to the first side of the damper gate and has a free end in sealing engagement with the first seal stop under pressure conditions, while a second seal is mounted to the second side of the damper gate and has a free end in sealing engagement with the second seal stop under the pressure conditions. In an alternative embodiment, the first seal is mounted to the first seal stop and has a free end in sealing engagement with the first side of the damper gate under pressure conditions, while the second seal is mounted to the second seal stop and has a free end in sealing engagement with the second side of the damper gate under the pressure conditions.

### PRIORITY CLAIM

This invention claims the benefit of priority of U.S. Provisional Application Ser. No. 61/675,209, entitled “Low Leakage Flue Damper For Positive Pressure Heating Appliance Venting System,” filed Jul. 24, 2012, the disclosure of which is hereby incorporated by reference in its entirety.

### BACKGROUND

The present embodiments generally relate to providing improved sealing of exhaust vents for fuel burning heating equipment.

Today's high efficiency heating equipment operates under a positive (above atmospheric pressure) vent pressure during operation. The high pressure comes from the use of high pressure fans used to push the combustion flue products through the equipment's heat exchanger.

There is generally a need for sealing the vents for this type of equipment when two or more heating units are commonly vented to the outside of a building. For example, if a first unit is operating, and second and third units are not operating, the flue gases from the first unit could flow into the other two heating units if the vent system is operating under a positive pressure. This potential flow of exhaust gases into the non-operating second and third units can cause equipment failures or leakage of flue gases into the occupied building space. Vent pressurization can occur due to wind loads or other changes to the building's exterior environment.

In prior assemblies, seals have been mounted onto the gate of the damper, and when sufficient amount of closure torque is applied to the gate, the seal deflects and seals against the gate stop of the damper. When the vent side of the damper gets pressurized, the left side of the gate is pressed against the gate stop. But, the right side of the gate is pushed away from the gate stop. This movement away from the gate stop reduces the pressure applied to the seal, which allows the applied air pressure to deflect the seal and allow leakage past the seal. This type of sealing method requires a high amount of torque, e.g., 128 in-oz of torque, to maintain minimal amount of leakage past the seal. Therefore, such prior attempts have generally been difficult or unsuccessful.

### SUMMARY

A flue damper comprises a damper gate having first and second sides, and first and second seal stops. In one embodiment, a first seal is mounted to the first side of the damper gate and has a free end in sealing engagement with the first seal stop under pressure conditions, while a second seal is mounted to the second side of the damper gate and has a free end in sealing engagement with the second seal stop under the pressure conditions. In one exemplary technique, when pressurization occurs in a vent, the first side of the damper gate presses the first seal against the first seal stop, and the second side of the damper gate applies pressure to the second seal causing it to expand and allowing it to maintain contact with the second seal stop.

In one example, the first seal generally comprises a C-shape having first and second opposing surfaces and an interior space disposed therebetween. The first surface of the first seal may be mounted to the first side of the damper gate, and the free end of the first seal may be on the second surface and points in a radially outward direction away from an inside of a pipe. Alternatively, the free end of the first seal may point in a radially inward direction towards an inside of a pipe. The second seal also generally may comprise a C-shape having first and second opposing surfaces and an interior space disposed therebetween, wherein the first surface of the second seal is mounted to the second side of the damper gate, and the free end is on the second surface and points in a radially inward direction towards an inside of a pipe.

The flue damper further comprises a shaft seal, wherein the first and second seal stops may extend from the shaft seal. The shaft seal may comprise at least one slot that receives at least a portion of the damper gate. At least one of the first or second seal stops may have an end region that comprises the same radius of curvature as an exterior surface of the shaft seal.

In an alternative embodiment, the first seal is mounted to the first seal stop and has a free end in sealing engagement with the first side of the damper gate under pressure conditions, while the second seal is mounted to the second seal stop and has a free end in sealing engagement with the second side of the damper gate under the pressure conditions.

Advantageously, the present embodiments allow for limited air leakage past the damper with low spring pressure holding the damper closed. This differs from prior designs that utilize high spring pressure to hold the damper closed. Notably, the designs use the applied pressure in the vent to hold the damper closed and increase the sealing force.

Other systems, methods, features and advantages of the invention will be, or will become, apparent to one with skill in the art upon examination of the following figures and detailed description. It is intended that all such additional systems, methods, features and advantages be within the scope of the invention, and be encompassed by the following claims.

### BRIEF DESCRIPTION OF THE DRAWINGS

The invention can be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 is a schematic of heating units commonly vented to an outside of a building.

FIG. 2 is a schematic diagram illustrating a first embodiment in which seals are mounted on seal stops.

FIG. 3 is a schematic diagram illustrating an alternative to the embodiment of FIG. 2 in which one of the seals is oriented in an alternative direction.

FIGS. 4-6 and 7A-7B are schematic diagrams illustrating a further alternative embodiment in which seals are mounted to a damper gate.

FIG. 8 is a sectional view of a shaft seal and portions of a damper gate and seal stops.

FIG. 9 illustrates testing results of prototype samples.

FIG. 10 illustrates additional testing results.

### DETAILED DESCRIPTION OF THE PREFERRED EMBODIMENTS

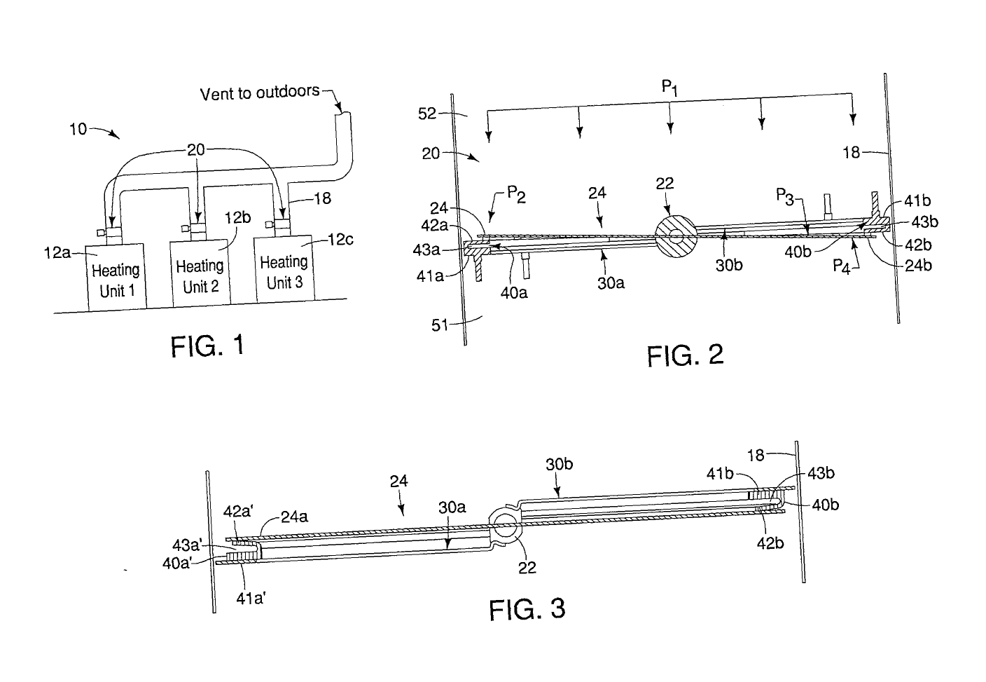

Referring to FIG. 1, an exemplary arrangement 10 of high efficiency heating equipment operates under a positive (above atmospheric pressure) vent pressure during operation. The high pressure comes from the use of high pressure fans used to push the combustion flue products through the equipment's heat exchanger. Sealing the vents for this type of equipment is generally needed when two or more heating units are commonly vented to the outside of the building, as depicted in FIG. 1. For example, if a first unit 12a is operating, and second and third units 12b and 12c are not operating, the flue gases from the first unit 12a could flow into the other two heating units 12b and 12c if the vent system is operating under a positive pressure. This potential flow of exhaust gases into the non-operating second and third units 12b and 12c can cause equipment failures or leakage of flue gases through respective flue dampers 20 into the occupied building space. Vent pressurization can occur due to wind loads or other changes to the building's exterior environment.

Referring to FIG. 2, a first embodiment of a low leakage flue damper 20 is shown positioned within one of the pipes 18 of the arrangement 10. It should be noted that the flue damper 20 may be used in conjunction with a pipe 18 that is round, square, or any other shape. Further, there is a damper inlet region 51 that may be connected to an equipment exhaust system, and a damper outlet region 52 that may be connected to a vent system.

The flue damper 20 generally comprises a shaft seal 22, a damper gate 24 extending from the shaft seal 22, first and second seal stops 30a and 30b, and first and second seals 40a and 40b. In this example, the first seal 40a is mounted to an outer region of the first seal stop 30a, while the second seal 40b is mounted to an outer region of the second seal stop 30b, as shown in FIG. 2.

The flue damper 20 has a sealed state in which a first side 24a of the damper gate 24 sealingly abuts the first seal 40a mounted to the first seal stop 30a, and where a second side 24b of the damper gate 24 sealingly abuts the second seal 40b mounted to the second seal stop 30b. As will be explained more fully below, when the vent is pressurized, the first side 24a of the damper gate 24 is pressed against the seal 40a. Further, in this embodiment, when pressure is applied to the second side 24b of the damper gate 24, and the second side 24b moves away from the second seal 40b, the second seal 40b expands from the pressurization of the internal portion of the seal, allowing it to maintain contact with the damper gate 24. In this state, flow through the pipe 18 at the damper 20 is substantially or entirely precluded.

The flue damper 20 further has an open state in which the damper gate 24 is rotated circumferentially, in this example in a clockwise direction, such that the first and second sides 24a and 24b of the damper gate 24 are no longer in sealing engagement with their respective seals 40a and 40b. In this latter state, venting of gases through the damper 20 is permitted.

It should be noted that various pressure forces may occur within the pipe 18 during the sealed state. For example, a pressure P₁ may be applied by vent pipe pressurization in the direction depicted in FIG. 2 during the sealed state. Additionally, a pressure P₂ may be applied by the first side 24a of the damper gate 24 pressing against the first seal 40a. Further, a pressure P₃ may be applied on the damper gate 24 that pushes the second side 24b away from the second seal 40b, and another pressure P₄ may be applied on the second seal 40b pressing onto the damper gate 24. Under the condition of all of these pressures, adequate sealing is maintained between the sides 24a and 24b of the damper gate 24 and the seals 40a and 40b, respectively.

In the embodiment of FIG. 2, the first seal 40a generally comprises a “C-shape” with opposing surfaces 41a and 42a, and an interior space 43a disposed therebetween. In this embodiment, the surface 41a is secured to the seal stop 30a, while the surface 42a abuts against the damper gate 24. A free end of the surface 42a points in a radially inward direction towards the inside of the pipe 18, as shown in FIG. 2. Further, the interior space 43a of the first seal 40a is open to the inside of the pipe 18, as shown in FIG. 2.

Further, in the embodiment of FIG. 2, the second seal 40b generally comprises a “C-shape” with opposing surfaces 41b and 42b, and an interior space 43b disposed therebetween. In this embodiment, the surface 41b is secured to the seal stop 30b, while the surface 42b abuts against the damper gate 24. A free end of the surface 42b points in a radially inward direction towards the inside of the pipe 18, as shown in FIG. 2. Further, the interior space 43b of the second seal 40b is open to the inside of the pipe 18, as shown in FIG. 2.

Referring to FIG. 3, in an alternative embodiment, a low leakage flue damper 20′ is generally similar to the flue damper 20 of FIG. 2, with a main exception that the position of an alternative first seal 40a′ is reversed. The alternative first seal 40a′ generally comprises a “C-shape” with a surface 41a′ secured to the seal stop 30a and an opposing surface 42a′ that abuts against the damper gate 24. However, in this example, a free end of the surface 42a′ points in a radially outward direction towards the outside of the pipe 18, and further, the interior space 43a′ of the first seal 40a′ is open to the outside of the pipe 18, as shown in FIG. 3.

In both the embodiments of FIGS, 2-3, the pressure P₂ applied by the first side 24a of the damper gate 24 pressing against the first seal 40a of FIG. 2, or the first seal 40a′ of FIG. 3, in order to cause a sealing engagement between the damper gate 24 and the seal stop 30. Further, in both the embodiments of FIGS. 2-3, pressurization into the interior space 43b of the second seal 40b causes the expansion of the second seal 40b, i.e., the free end of the surface 42b is allowed to move further away from the surface 41b. This pressurization concept, with its significant advantages, is more fully illustrated in the close-up views of to FIGS. 7A-7B below. The pressurization of the seals occurs for the seal 40b in the embodiments of FIGS. 2-3, as well as the alternative first seal 40a′ in the embodiment of FIG. 3 since it has an interior space 43a′ that is exposed to pressurized flow P₁ from the back drafting pressure from the venting to the outdoors. Thus, advantageously, in the embodiment of FIG. 2 there is one expandable pressurized seal 40b, and in the embodiment of FIG. 3 there are two expandable pressurized seals 40a′ and 40b.

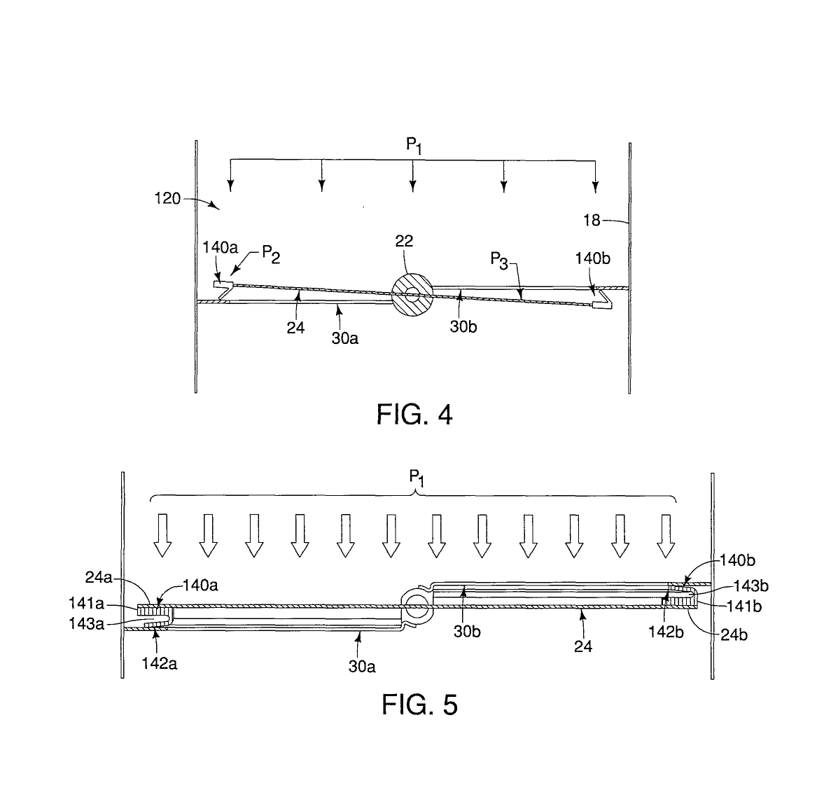

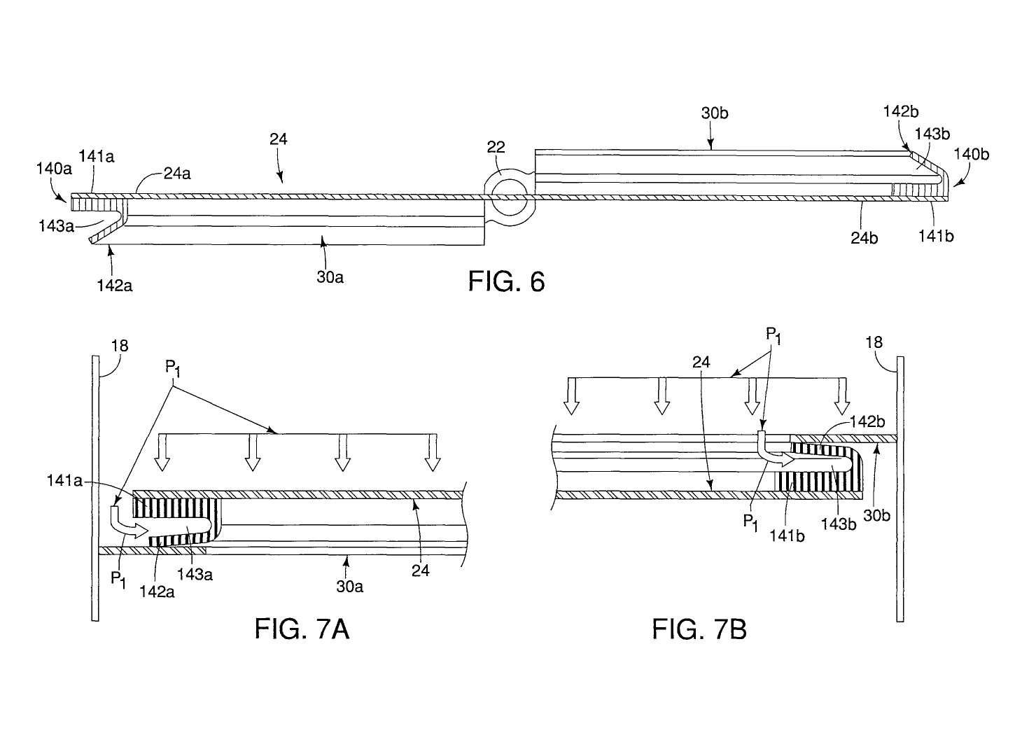

Referring now to FIGS. 4-6 and 7A-7B, an alternative embodiment of a flue damper 120 is shown. The flue damper 120 is similar to the dampers 20 and 20′ of FIGS. 2-3, with a main exception that alternative seals 140a and 140b are mounted to the first and second sides 24a and 24b, respectively, of the damper gate 24, instead of being mounted to the seal stops.

The seals 140a and 140b of FIGS. FIGS. 4-6 and 7A-7B are similar to the C-shaped seals 40a and 40b of FIG. 3. However, in the embodiment of FIGS. FIGS. 4-6 and 7A-7B, the first seal 140a has a first surface 141a that is mounted to the damper gate 24 and may be disposed vertically above a second surface 142a having a free end that seals against the seal stop 30a. Similarly, the second seal 140b has a first surface 141b that is mounted to the damper gate 24 and may be disposed vertically beneath a second surface 142b having a free end that seals against the seal stop 30b.

In the embodiment of FIGS. FIGS. 4-6 and 7A-7B, when pressurization occurs in the vent, the first side 24a of the damper gate presses the first seal 140a against the seal stop 30a. The second side 24b of the damper gate 24 under pressure moves away from the seal stop 30b, but as in the embodiment of FIGS. 2-3, the pressure is also applied to the second seal 140b causing it to expand and allowing it to maintain contact with the seal stop 30b, as depicted in FIG. 4.

Notably, to the extent that pressure P₁ from the vent is directed into the interior spaces 143a and 143b of the first and second seals 140a and 140b, as depicted in FIGS. 7A-7B, respectively, then the first and second seals 140a and 140b expand as shown in FIG. 4 by having the free ends of the respective second surfaces 140a and 140b deflect in an at least partially vertical manner that still maintains appropriate sealing contact with the respective seal stops 30a and 30b.

Advantageously, the designs of the present embodiments use the applied pressure in the vent to hold the damper closed and increase the sealing force, thereby allowing for limited air leakage past the damper with low spring pressure holding the damper closed. This differs from prior designs that utilize high spring pressure to hold the damper closed. As a further advantage, such seal designs allow for molding the seal thicker, which makes them moldable at a lower cost and with fewer potential problems removing the seal from the mold.

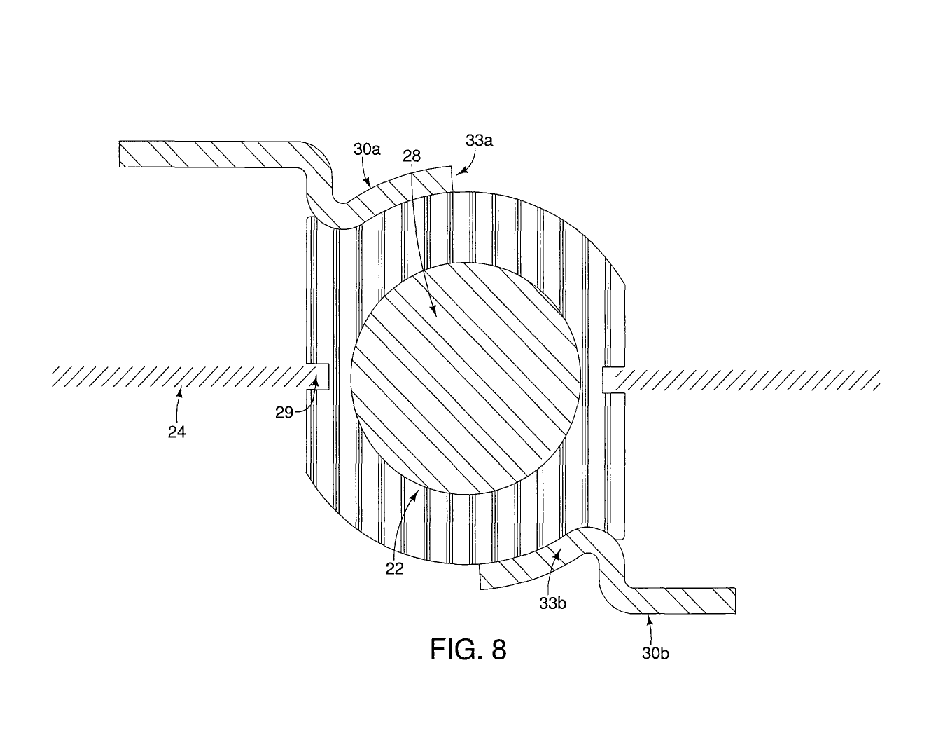

Referring to FIG. 8, further exemplary features of an interface between the shaft seal 22, the damper gate 24, and the seal stops 30a and 30b are shown. The shaft seal 22 surrounds a damper gate shaft 28. The shaft seal 22 may comprise at least one slot 29 that receives a portion of the damper gate 24, and a suitable adhesive sealant material may be used at this junction. Additionally, the seal stops 30a and 30b have ends 33a and 33b, respectively, that comprise the same radius of curvature as exterior surfaces of the shaft seal 22. This allows constant contact during damper gate rotation from a closed to an open position, and limits pressure leakage when the damper gate 24 is in the closed position. The ends 33a and 33b of the seal stops 30a and 30b may also be used to limit the damper rotation in the open position.

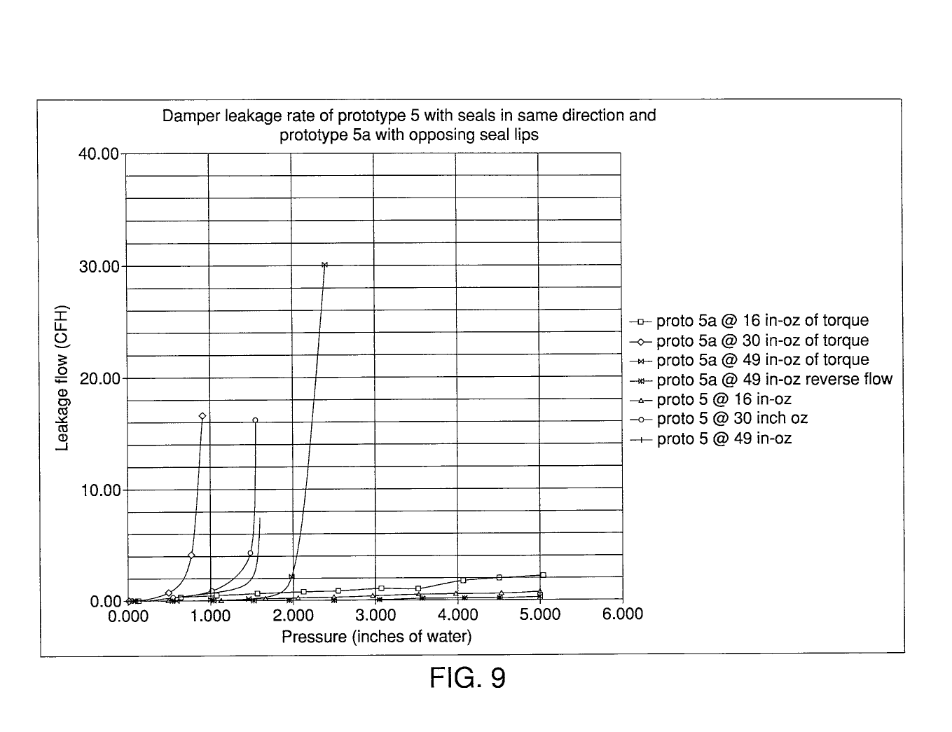

Referring now to FIG. 9, testing results of prototype samples are shown. The “Proto 5” sample is built using a seal method similar to prior techniques, while the “Proto 5a” uses a seal method as illustrated in FIGS. FIGS. 4-6 and 7A-7B. The chart shows the change in cubic feet per hour (CFH) leakage past the seal versus the change in pressure at three gate closure torque levels. From the chart indicating the testing of “Proto 5” at three torque levels, the leakage past the seal is clearly illustrated. The leakage at 16 in-oz of closure torque starts at around 0.5 inches of water pressure. Nearly doubling the torque to 30 in-oz of closure torque increases the leakage applied pressure to around 1 inch of water pressure.

Looking at the performance of the “Proto 5a” sample leakage at 16 in-oz of closure torque, it starts leaking around 2.5 inches of water pressure, which yields a 400% increase in leakage resistance relative to the prior technique of the “Proto 5” sample. Nearly doubling the torque to 30 in-oz of closure torque increases the leakage applied pressure to around 5 inches of water pressure, which yields a 400% increase in leakage resistance relative to the prior technique of the “Proto 5” sample.

To verify the operation of the seal method of FIGS. FIGS. 4-6 and 7A-7B, the pressure was applied onto the opposite side of the damper (illustrated by the “Proto 5a” at 49 in-oz reverse flow curve. The resulting leakage past the seal was similar to the leakage results of the “Proto 5” testing.

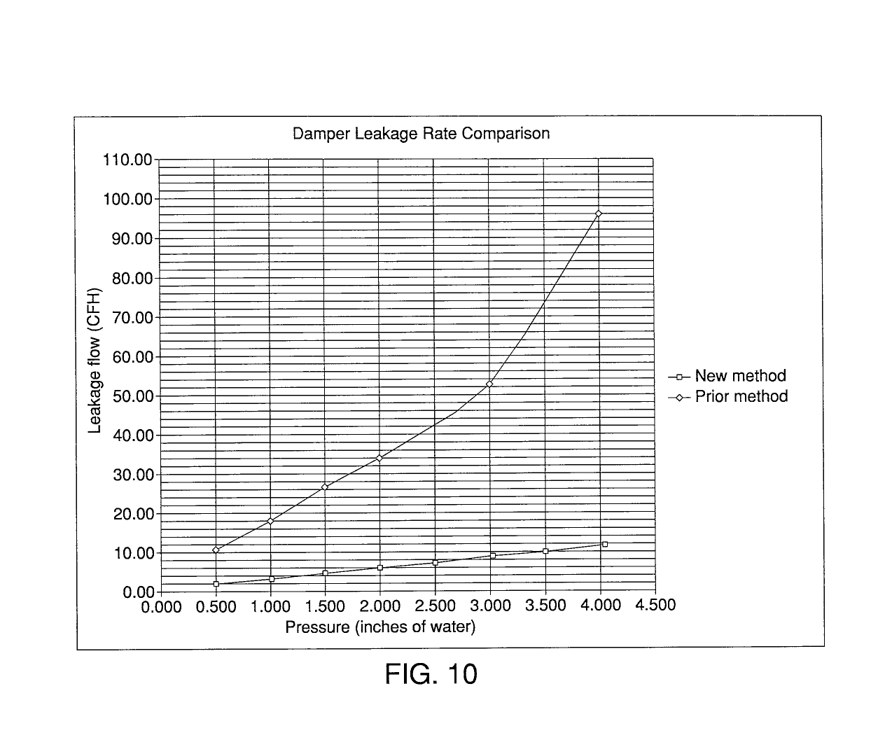

Referring now to FIG. 10, another comparison was performed for the “Proto 5a” seal method as illustrated in FIGS. FIGS. 4-6 and 7A-7B, versus a previously known damper. is Leakage rates were compared. This additional testing illustrates the clear reduction in damper leakage rate at all applied pressure levels at reduced applied gate closure torque.

As noted above, the present embodiments advantageously allow for limited air leakage past the damper with low spring pressure holding the damper closed, as reflected in the data of FIGS. 9-10. By using the applied pressure in the vent to hold the damper closed and increase the sealing force, an improvement is made over prior designs that utilize high spring pressure to hold the damper closed.

While various embodiments of the invention have been described, the invention is not to be restricted except in light of the attached claims and their equivalents. Moreover, the advantages described herein are not necessarily the only advantages of the invention and it is not necessarily expected that every embodiment of the invention will achieve all of the advantages described.

I claim:

1. A flue damper, comprising:
a damper gate having first and second sides;
first and second seal stops;
a first seal mounted to the first side of the damper gate and having a free end in sealing engagement with the first seal stop under pressure conditions; and
a second seal mounted to the second side of the damper gate and having a free end in sealing engagement with the second seal stop under the pressure conditions.

2. The flue damper of claim 1, wherein, when pressurization occurs in a vent, the first side of the damper gate presses the first seal against the first seal stop, and
wherein the second side of the damper gate under pressure applies pressure to the second seal causing it to expand and allowing it to maintain contact with the second seal stop.

3. The flue damper of claim 1, wherein the first seal generally comprises a C-shape having first and second opposing surfaces and an interior space disposed therebetween.

4. The flue damper of claim 3, wherein the first surface of the first seal is mounted to the first side of the damper gate, and the free end of the first seal is on the second surface and points in a radially outward direction away from an inside of a pipe.

5. The flue damper of claim 3, wherein the first surface of the first seal is mounted to the first side of the damper gate, and the free end of the first seal is on the second surface and points in a radially inward direction towards an inside of a pipe.

6. The flue damper of claim 3, wherein the second seal generally comprises a C-shape having first and second opposing surfaces and an interior space disposed therebetween.

7. The flue damper of claim 6, wherein the first surface of the second seal is mounted to the second side of the damper gate, and the free end is on the second surface and points in a radially inward direction towards an inside of a pipe.

8. The flue damper of claim 1, wherein, when pressurization occurs in a vent, the first side of the damper gate under pressure applies pressure to the first seal causing it to expand and allowing it to maintain contact with the first seal stop, and
wherein the second side of the damper gate under pressure applies pressure to the second seal causing it to expand and allowing it to maintain contact with the second seal stop.

9. The flue damper of claim 1, further comprising a shaft seal, wherein the first and second seal stops extend from the shaft seal.

10. The flue damper of claim 9, wherein the shaft seal comprises at least one slot that receives at least a portion of the damper gate.

11. The flue damper of claim 9, wherein the first seal stop has an end region that comprises the same radius of curvature as an exterior surfaces of the shaft seal.

12. A flue damper, comprising:
a damper gate having first and second sides;
first and second seal stops;
a first seal mounted to the first seal stop and having a free end in sealing engagement with the first side of the damper gate under pressure conditions; and
a second seal mounted to the second seal stop and having a free end in sealing engagement with the second side of the damper gate under the pressure conditions.

13. The flue damper of claim 12, wherein the first seal generally comprises a C-shape having first and second opposing surfaces and an interior space disposed therebetween.

14. The flue damper of claim 13, wherein the first surface of the first seal is mounted to the first seal stop, and the free end of the first seal is on the second surface and points in a radially outward direction away from an inside of a pipe.

15. The flue damper of claim 13, wherein the first surface of the first seal is mounted to the first seal stop, and the free end of the first seal is on the second surface and points in a radially inward direction towards an inside of a pipe.

16. The flue damper of claim 13, wherein the second seal generally comprises a C-shape having first and second opposing surfaces and an interior space disposed therebetween.

17. The flue damper of claim 16, wherein the first surface of the second seal is mounted to the second seal stop, and the free end is on the second surface and points in a radially inward direction towards an inside of a pipe.

18. A method for reducing leakage through a flue damper, the method comprising:
providing a damper gate having first and second sides;
providing first and second seal stops;
mounting a first seal to the first side of the damper gate; and
mounting a second seal to the second side of the damper gate,
wherein, under pressure conditions, a free end of the first seal is in sealing engagement with the first seal stop, and a free end of the second seal is in sealing engagement with the second seal stop.

19. The method of claim 18, wherein at least one of the first and second seals expands when pressure is applied such that the free end of the at least one of the first and second seals is oriented more parallel to a pipe in an expanded state.

20. The method of clam 18, wherein at least one of the first and second seals generally comprises a C-shape having first and second opposing surfaces and an interior space disposed therebetween.
